(19) United States
(12) Patent Application Publication
(10) Pub. No.: US 2016/0360929 A1
(43) Pub. Date: Dec. 15, 2016

(54) Detachable Handle and Cookware Vessel

(71) Applicants: Stanley Kin Sui CHENG, Vallejo, CA (US); MEYER INTELLECTUAL PROPERTIES LTD., Vallejo, CA (US)

(72) Inventors: Roberto Tarenga, Milan (IT); Roberto Recenti, Milan (IT)

(21) Appl. No.: 14/388,425

(22) PCT Filed: Apr. 3, 2014
(86) PCT No.: PCT/US2014/032882

§ 371 Date: Sep. 26, 2014

Related U.S. Application Data
(60) Provisional application No. 61/808,481, filed on Apr. 4, 2013.

(51) Int. Cl. A47J 45/07

(52) U.S. Cl. CPC A47J 45/071

(57) ABSTRACT

The cookware vessel has an outward extending bracket below the rim which preferably includes a channel bracket for receiving a locking key attached to the detachable handle. The detachable handle has a proximal end which is intended to receive the extending bracket of the vessel and position the key for locked engagement when rotated by a level. The distal portion of the handle is for gripping and optionally hanging the handle or a pan engaged in the handle.

### CROSS REFERENCE TO RELATED APPLICATIONS

The present application claims the benefit of priority to the US Provisional patent application of the same title that was filed on Apr. 4, 2013, having application Ser. No. 61/808,481, and is incorporated herein by reference.

The present application also claims the benefit of priority to the International Patent application that was filed on Apr. 3, 2014, having application no. PCT/US2014/032882, and which is incorporated herein by reference.

The present application is a Continuation-in-Part of said International Patent Application.

### BACKGROUND OF INVENTION

The present invention relates to a cookware articles, and in particular to a handle that is detachable from pots and pans, and a pot or pan adapted to receive said handle.

Of the numerous variations in prior art detachable handles for cookware, considerable mechanical complexity is required within the handle device, as well as a particular structure for engaging the cookware vessel, usually in outward extending flange it has a lockable mating feature designed to engage in internal fixture of the detachable handle.

Such devices tend to exhibit considerable mechanical “play”, even when securely holding the vessel, which can make users or consumers feel insecure in their use.

It is therefore a first object of the present invention to overcome the above deficiencies of the prior art, as well as provide additional benefits described in further detail below.

### SUMMARY OF INVENTION

In the present invention, the first object is achieved by providing an article of cookware, comprising a substantially horizontal bottom, substantially upright sidewalls extending upward from and encircling said bottom to form a fluid retaining interior region, the sidewalls terminating at an upward rim of the vessel, an outward extending bracket connecting to the upright sidewall of the vessel, the bracket having a lower wedge shaped outer portion and an upper portion opposing the lower wedge shaped portion, at least one detachable handle extending outward from said substantially upright sidewall, the handle having; a forward recess for receiving and selectively connecting to the wedge shaped outer portion of the bracket, a rotating locking key with an upper portion contained in a bore in the handle and a wedge shaped terminal portion of the key extends beyond a lower boundary of the bore wherein rotating the key in a first direction is operative to engage the wedge shaped terminal portion thereof to an upper portion of the bracket and rotating the key to a second direction opposite the first direction is operative to release the wedge shaped terminal portion thereof from the upper portion of the bracket.

A second aspect of the invention is characterized in that the key has a means for latching connection to the upper portion of the bracket.

Another aspect of the invention is characterized in that rotating the key to a locked position is operative to engage the wedge shaped terminal thereof to engage a first complimentary wedge shaped upper portion of the bracket.

Another aspect of the invention is characterized in that a first complimentary wedge shaped portion of the bracket is at the edge of a plate disposed in the bracket.

Another aspect of the invention is characterized in that the plate is fixed in a generally horizontal cantilevered position in a portion of the bracket which is proximal to the connection to the sidewall of the vessel and the plate is capable of flexing to allow the first complimentary wedge shaped portion to move upward to engage the lower portion of the key.

Another aspect of the invention is characterized in that the forward recess of the handle has a wedge shaped lower portion disposed forward of the key to receive the lower wedge shaped portion of the bracket.

Another aspect of the invention is characterized in that the handle has means to identify if the key is in the first or second position corresponding to rotation between the first and second directions.

Another aspect of the invention is characterized in that the engaging portion of the bracket and handle are covered by a metal shell.

Another aspect of the invention is characterized in that the handle is urged forward in a first upward position to receive the outward extending bracket and rotated downward thereafter to a second position to present the first complimentary wedge shaped upper portion of the bracket to receive the wedge shaped terminal portion of the key.

Another object of the invention is achieved by providing a handle for an article of cookware comprising an elongated grip portion having a distal end and a proximal end for connection to a cookware vessel, a forward recess at the proximal end of the grip portion, a cylindrical bore in the grip portion, a locking key disposed for rotation with the cylindrical bore, the key having an upper end with lever that extends over an upper portion of the handle and lower end with a wedge shape portion that extends into the forward recess.

Another aspect of the invention is characterized in that the portion of wedge shaped end of the key is rotatable from a first position directed at the grip portion and a reversed position by the lever.

Another aspect of the invention is characterized in that the key is latchable in the first and reversed positions.

Another aspect of the invention is characterized in that the key has cylindrical wall with dimples on opposing sides for receiving a ball that is urged into said dimples by a spring, wherein the spring provides the latching force.

Another aspect of the invention is characterized in that the key has an annular groove in the cylindrical wall above the lower portion.

Another aspect of the invention is characterized in that the key is held in rotary engagement in the handle by a “U”-shaped bracket that engage the annular groove in the cylindrical wall of the key.

Another object of the invention is achieved by providing a handle for an article of cookware comprising an elongated grip portion having a distal end and a proximal end for connection to a cookware vessel, a forward recess at the proximal end of the grip portion, an upper recess at the proximal end of the grip portion, a plate disposed in the upper recess having a cylindrical bore a locking key disposed for rotation with the cylindrical bore, the key having an upper end with a rotation means and lower end with a wedge shape portion that extends into the forward recess.

Another aspect of the invention is characterized in that the plate has detents on opposing sides for engaging an underside portion of the grip portion for retaining the plate in the upper recess.

Another aspect of the invention is characterized in that the plate has a recessed upper surface that receives a lever that is attached to upper end of the key to provide the rotation means

Another aspect of the invention is characterized in that the portion of wedge shaped end of the key is rotatable from a first position directed at the grip portion and a reversed position by the lever.

Another aspect of the invention is characterized in that the key is latchable in the first and reversed positions.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is an exterior perspective view of the handle connected to the cookware vessel, whereas FIG. 1B is a top plan view showing primarily the handle portion and locked engagement with the cookware vessel, in contrast FIG. 1C showing the same top plan view with the handle in an unlocked position.

FIG. 2 is a cross-sectional elevation of the handle and connected portion of the vessel corresponding to FIG. 1B.

FIG. 3 is a perspective exploded view of the handle and connecting portion of the vessel.

FIG. 4 is another perspective exploded view of the handle connecting portion of the vessel.

FIGS. 5 A through C are exterior front elevation views of the handle illustrating the position of the key as the lever is rotating from an unlocked position in FIG. 5A to a locked position in FIG. 5C, with FIG. 5B illustrating the intermediate position. FIG. 5D and FIG. 5E illustrate respectively an exterior perspective elevation of the cookware vessel and the connecting bracket and a shaded cross-sectional perspective view thereof.

FIG. 6A through 6D illustrate via a series of shaded cross-sectional elevation a sequence of steps inserting and locking the handle to the connecting bracket.

FIGS. 7A and 7B are shaded perspective sectional views of the locking portion of the handle in an unlocked and locked connection to the connecting bracket respectively.

FIGS. 8A and 8B are shaded cross-sectional elevation views of the locking portion of the handle in an unlocked and locked connection to the connecting bracket respectively.

FIG. 9 is an exploded perspective view of another embodiment of the invention.

FIG. 10 is a partially transparent perspective view of the latching bracket of the embodiment of FIG. 9.

FIG. 11 is a cross-sectional elevation of the embodiment of the invention of FIG. 9-10 in which the handle is connected to the latching bracket and locked in place by the rotated key.

FIG. 12 is an exploded perspective view showing the opposite side of selected components from FIG. 9 to better illustrate features thereof.

### DETAILED DESCRIPTION

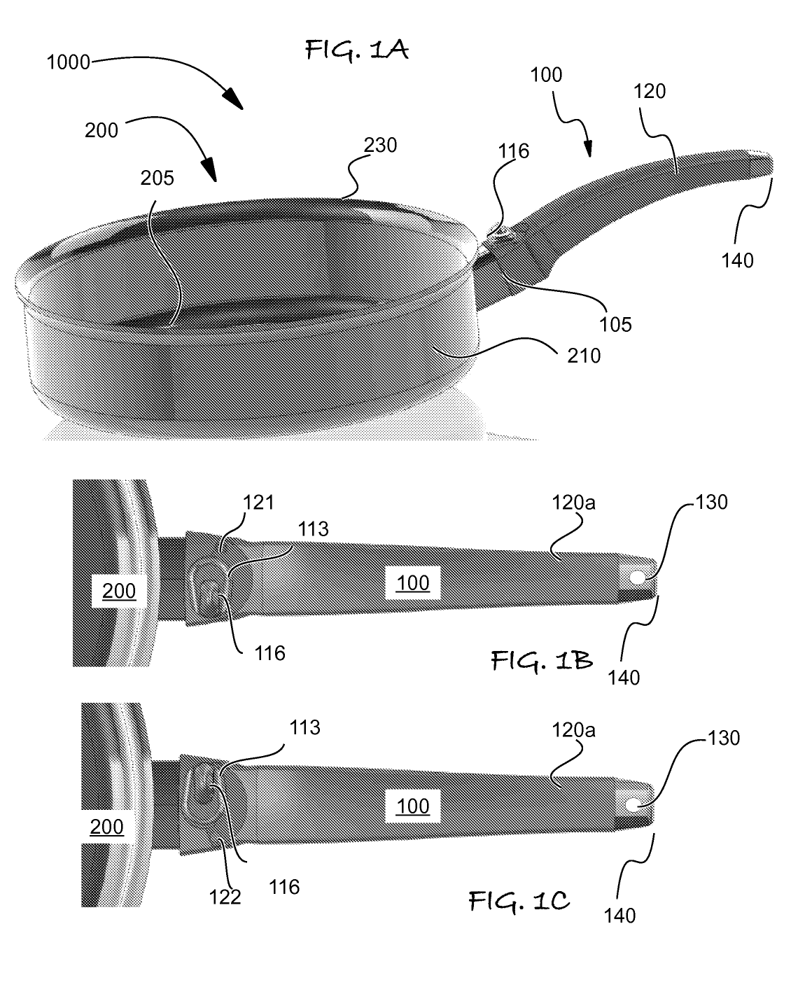

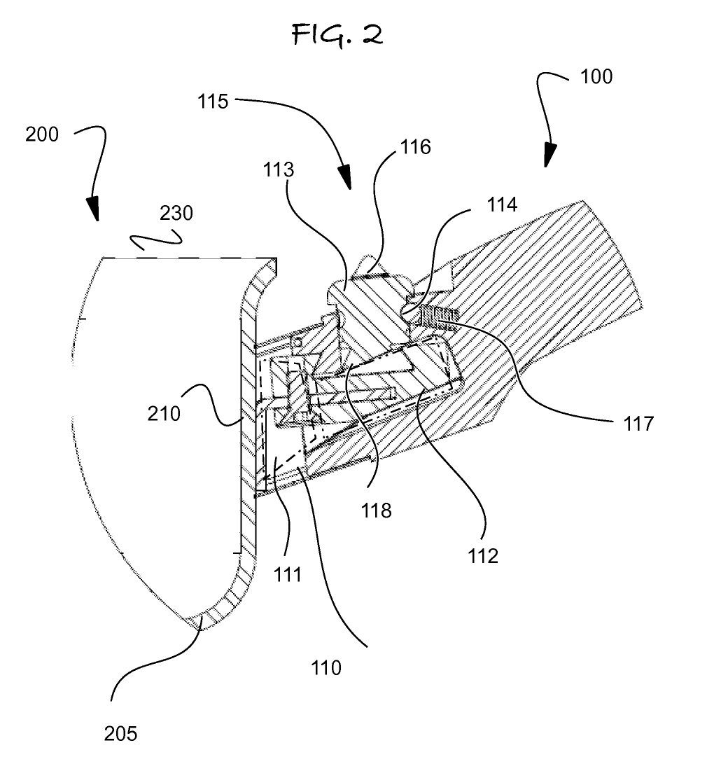

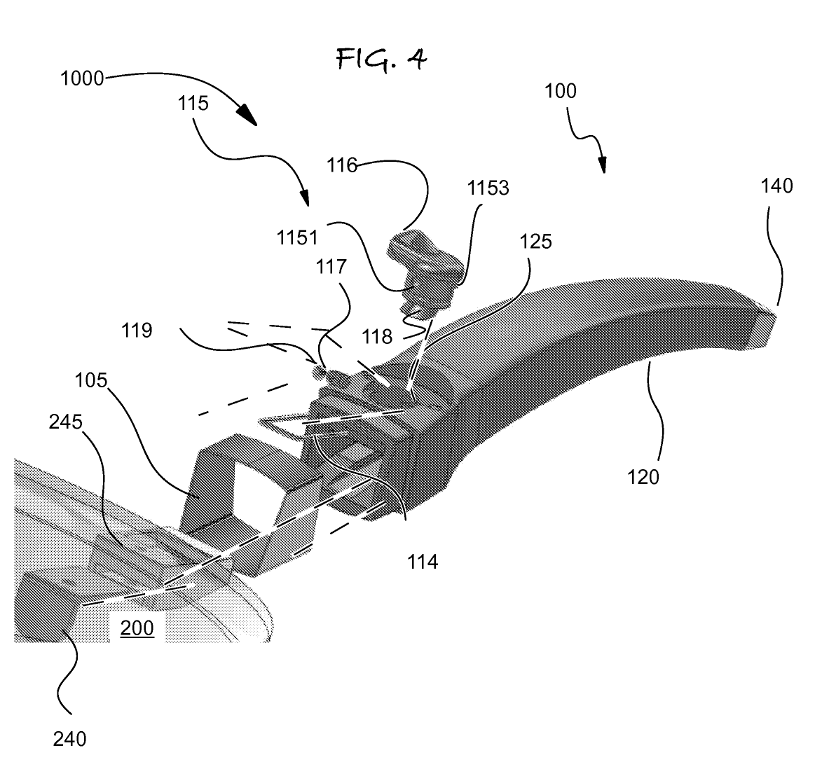

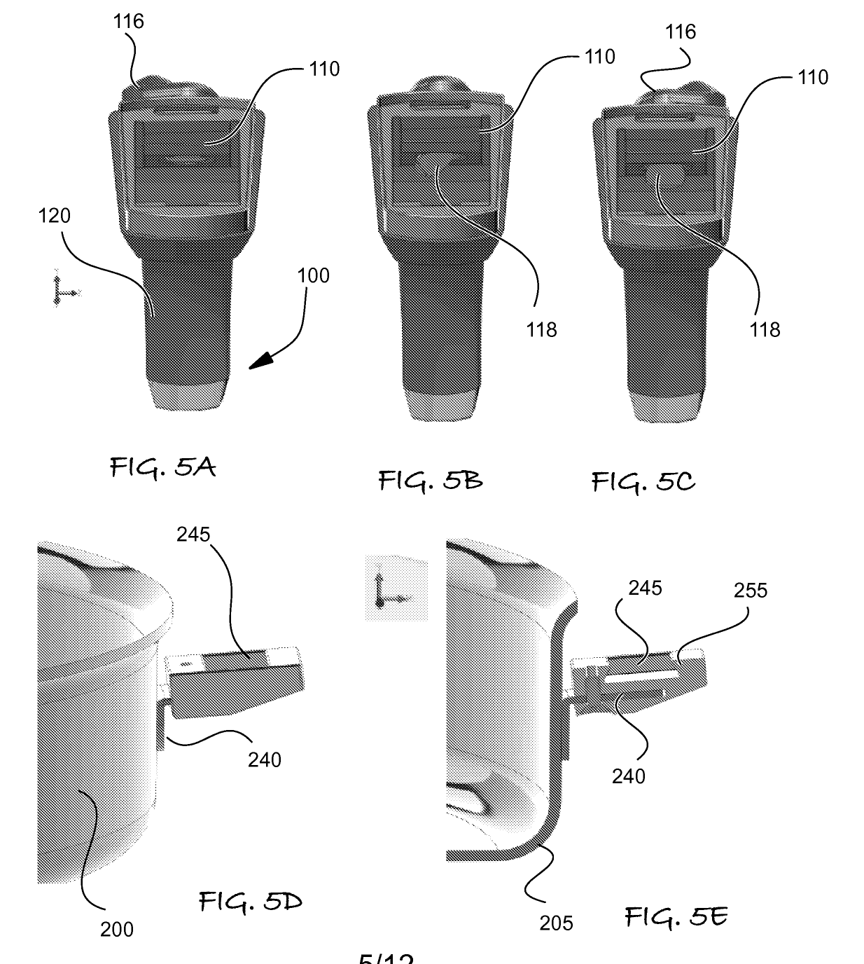

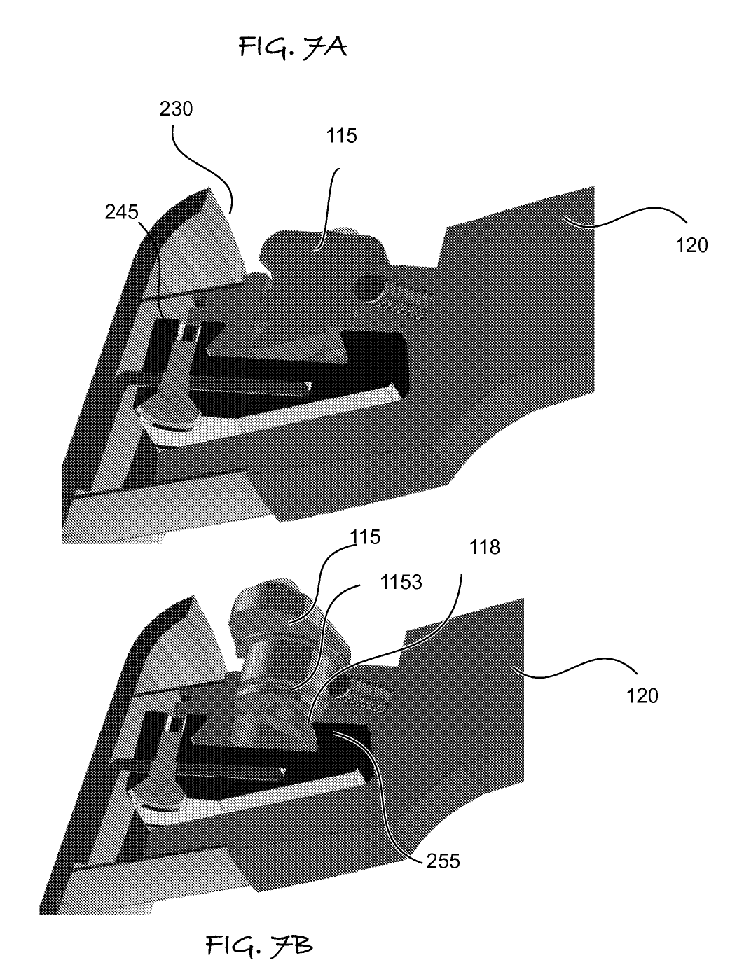

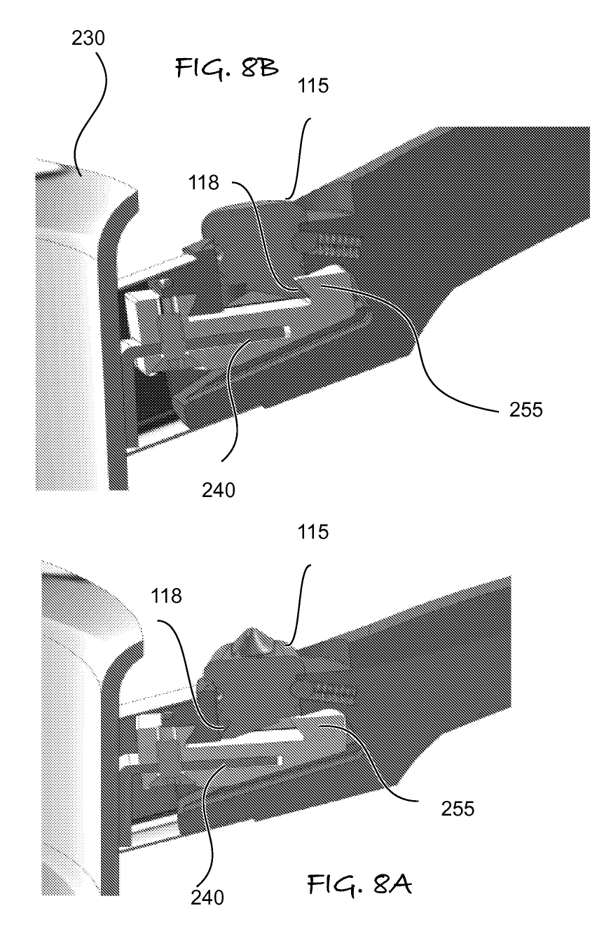

Referring to FIGS. 1A through 12, wherein like reference numerals refer to like components in the various views, there is illustrated therein a new and improved Detachable Handle and Cookware Vessel, generally denominated 1000 herein.

In accordance with the present invention, the detachable handle 100 has a forward recess 110 adapted to engage in an outward extending bracket 240 which is attached to the sidewall 210 of cookware vessel 200. The bracket is essentially a rectangular plate bent to a general L-shape having a portion extending outward from the side of the vessel, with the flat plane of the outward extending portion of the plate parallel to the bottom of the cookware vessel 205. Cookware vessel 200 has bottom portion 205 surrounded by connecting substantially upright sidewalls 210 which terminate at a rim 230. Distal from the forward recess 110 is the grip portion of the handle 120, which is optionally followed by a hanging hole 130 at the distal end 140. The forward recess 110 has a front or forward opening in a housing 105 that is attached to the grip portion 120 of the handle 100. The grip portion adjacent housing 105 has a cylindrical bore that supports a rotating key 115. This rotating key 115 engages a locking means formed on the bracket 240. As illustrated in the FIG.'s, the locking means is preferably a channel bracket 245 on the surface of the bracket 240. The key 115 is optionally rotated by a lever 116 that extends above the upper surface 120a of the grip portion of the handle 120. The forward housing 105 is connected to the grip portion 120 of the handle 100. The forward housing 105 is a preferably metal to provide a protective flame guard to protect the grip portion of the handle 120 from heating. The key can be rotated by any rotation means, such as the lever 116, or via a removable handle, such as a screw driver, wrench and the like that can engage a mating inner slot or polygon in the center o the key, or an outer polygon shape, and the like.

The second portion 112 of the recess 110 is formed in the grip portion of the handle 120, whereas the first portion 111 is generally defined by the forward portion of the housing 105.

The bracket receiving recess 110 has a first and exterior 111 portion wider than the bracket 240 but slanting inward to a second interior portion 112 that substantially conforms to the bracket's 240 width.

It should be appreciated that the key receiving means of the bracket 240 is a portion the interior angled edge 255 portion of the bracket 240. Key 115 enter the second interior portion 112 via a hole in the top of the handle 120, in which the key 115 provides locking engagements therein upon insertion and rotation. The handles 120 is secured to the vessel 200 as the box like second recess 112 receives the bracket portion 245 for latching engagement of the key 115, which upon rotation has a wedge lower portion 118 that is urged against the with the interior angled edge 255 portion of the bracket 240.

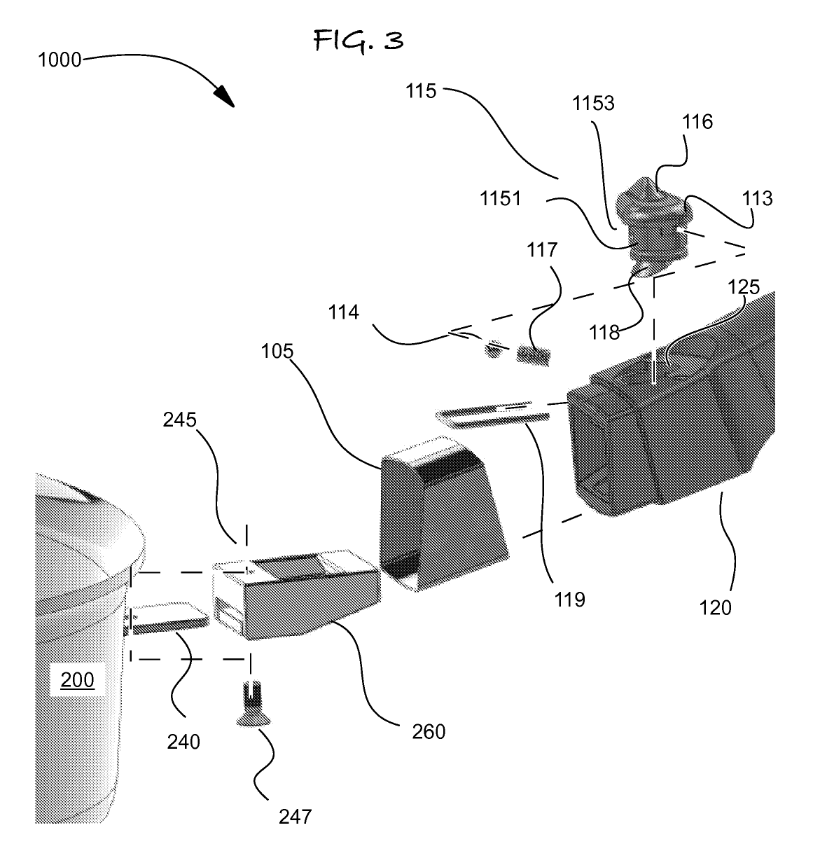

In a more preferred embodiment illustrated in FIGS. 3-5, a spring 117 is deployed to urge a ball 114 into hemispherical dimples 1151 on opposing cylindrical vertical surfaces 1152 of the key 115. The spring 117 urges the ball 114 to seat within the dimples 1151, and thus provides a latching retaining force to oppose accidental rotation. The key 118 optionally has an upper portion that is threaded to engage mating threads in the receiving bore. The key 115 is rotated by lever 116 and can be retained in the bore by various means, including radial protrusion that drops into a slot at the edge of the bore, which after rotation of the key 115 is retained by lower rim surface of the circular bore. Alternatively, the key can be formed of a mated upper and lower half in which the mating interface provide an annular recess to engage an inward rim of the bore. The inward rim is thinner than the recess and engages the key. It should be appreciated that the engagement of the key and bore can also be provided by a bearing.

Alternatively, as shown in the first embodiment, a U-shaped pin 119 retains the key 115 within the bore or hole in the top of the handle 100 by engaging an annular groove 1153 with the lower portion of the cylindrical wall 1152. Upright sides of the “U” shaped pin 119 engage opposing sides of the annular groove 1153. This configuration prevents the key 115 from popping out of the bore.

The spring 117 is preferably selected to provide a sufficient level of resistance to rotation of the lever 116, such that it is generally latched once turned to be open or closed position as shown in FIGS. 1B and 1C.

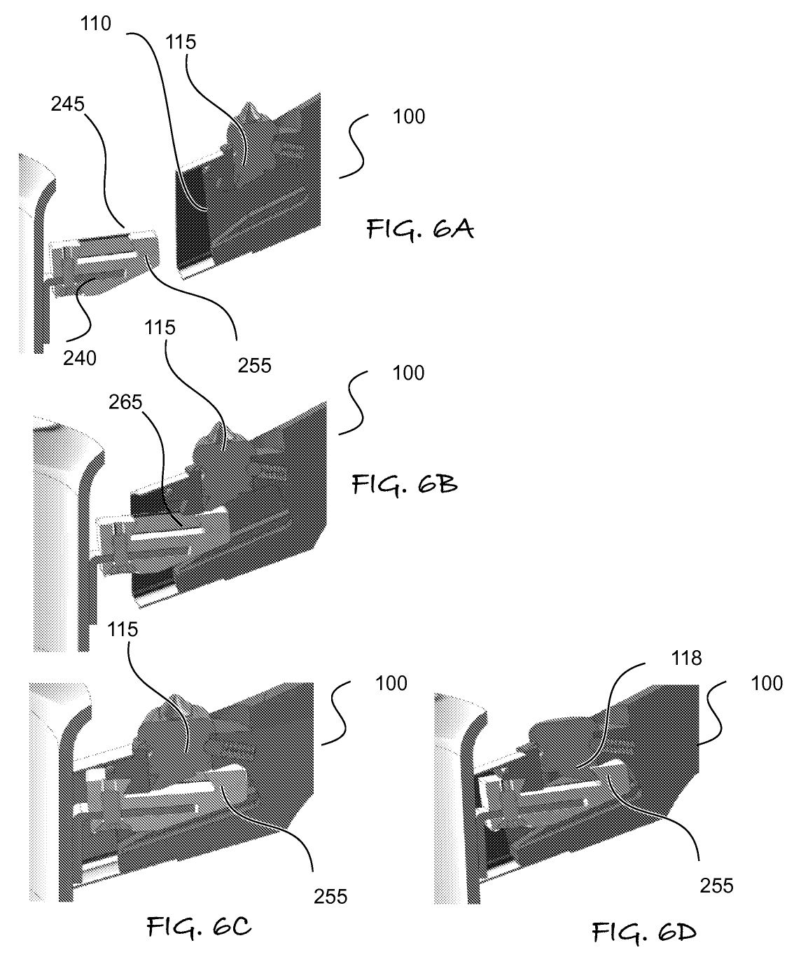

The channel bracket 245 preferably provides an interior angled edge 255 that engages in an angular protuberance 118 on the bottom of the key 115. The annular protuberance 118 is a partial conical section that is only engages the opposite edge 255 when the key 115 is rotated to the locket position shown in FIGS. 6D, 7B and 8B.

The channel bracket 245 is optionally a monolithic block that slides over the L-bracket 240 and is secured thereto by a screw 247. It is preferably formed by two inverted trapezoidal blocks fastened to the top of the bracket 240, with the primary axis of the channel within the bracket 245 disposed transverse to the primary access of the substantially rectangular bracket 240. Hence, the primary axis of the channel bracket 245 is also transverse to the primary axis of the handle 100, which extends along the elongated grip portion 240.

The recess 110 in the handle 100 preferably includes at least one ramp shaped side within the forward portions 111, and more preferably on the bottom surface to urge the outer portion of the bracket 240 into the inner portion 112 of the recess to position the channel bracket 245 in the proper location for receiving the key 115.

The channel bracket 245 has a lower exterior portion 260 which is wedged or sloped at the bottom to adjust the entry angle into recess 110 to facilitate the movement of the key 115 downward into the middle channel 265 formed within the channel bracket 245, as illustrated in FIG. 6A-6D. Once the key 115 is positioned in the middle channel 265 of channel bracket 245, it can be rotated by the lever 116 to lock the handle 100 to the bracket 250 and cookware vessel 200.

An oval plate 113 is preferably disposed between the key 115 and the lever 116 to alternatively cover and expose a red 121 or green 122 indicator button formed on the upper face 120a of the grip portion to indicate the lock status, as show in FIGS. 1B and 1C. It should be appreciated that other symbols, letters or signs can be deployed to indicate the open or locked position of the handle 100. It should be understood that the lever can be directly or indirectly couple to the key, such as via a cam if it is desirable to push or pull a lever in the axis of the handle to rotate the key 115.

The outer edge dimensions of the housing 105 of the handle 100 preferably conforms to the shape and slope of the vessel sidewall 220 so that the fully inserted and locked handle 100 meets the vessel sidewall 230 on two or more sides to assure and confirm a proper engagement.

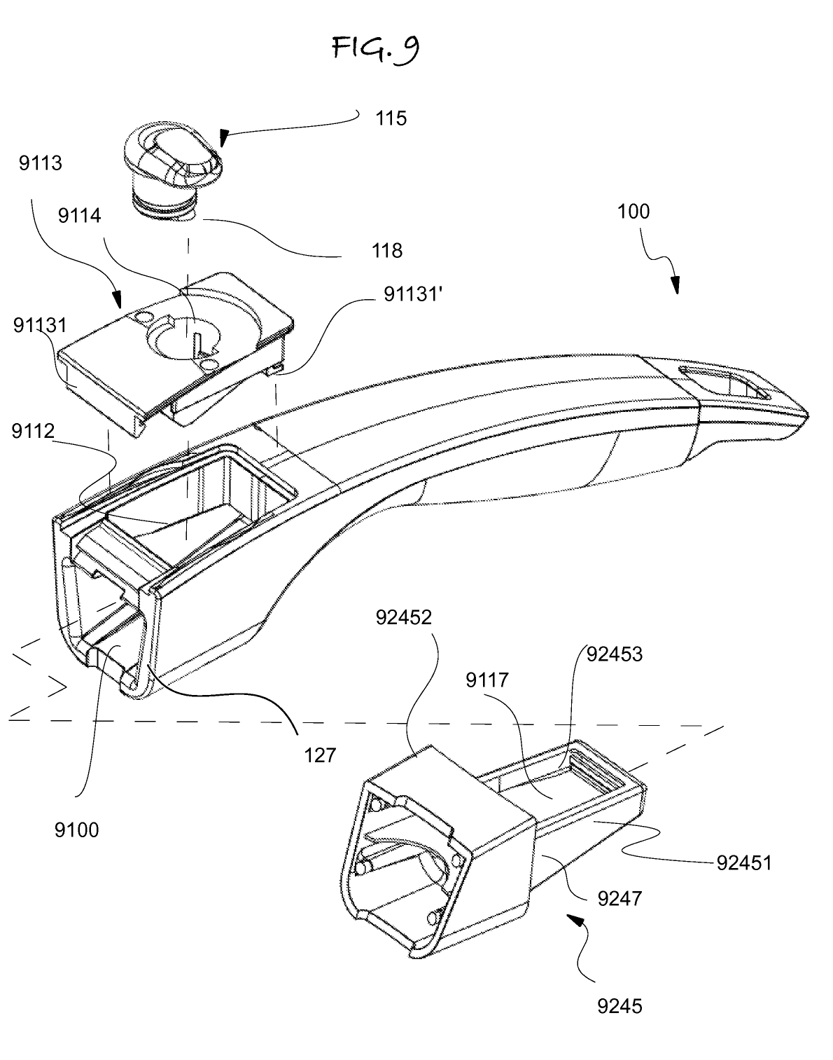

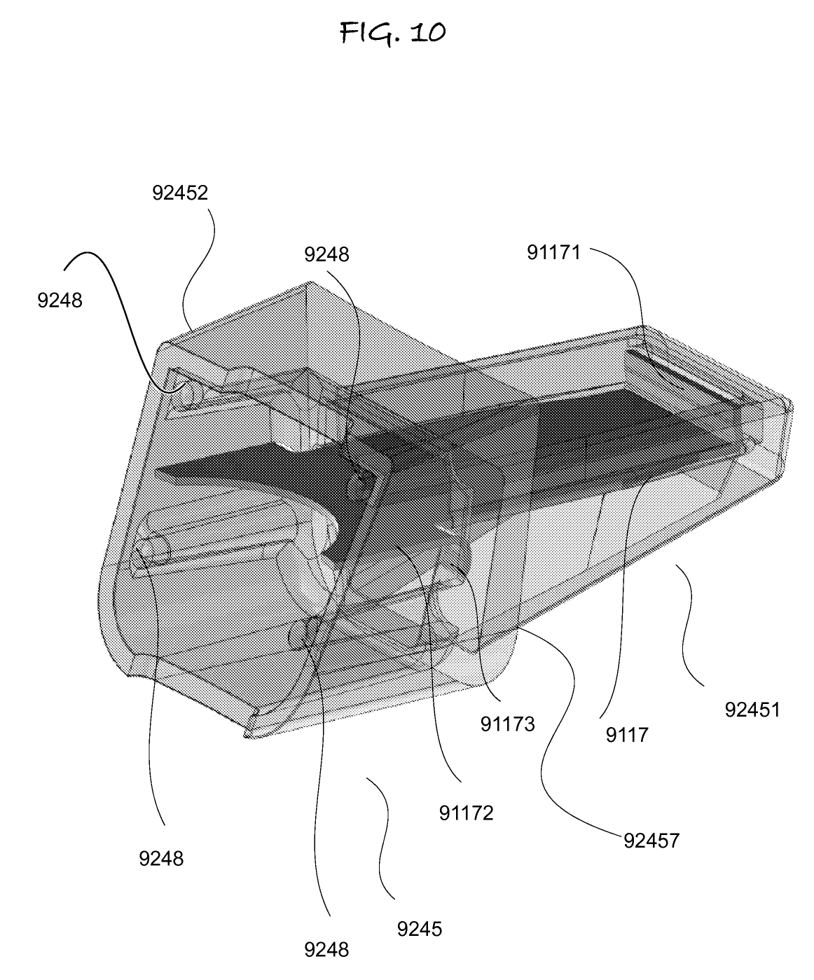

An alternative embodiment of the invention is illustrated in FIG. 9A-12 in which a latching bracket 9245 is attached to the sidewall 210 of the vessel 200. The latching bracket 9245 is preferably a strong cast metal, such as steel, and is either screwed, welded or riveted to the vessel sidewall 210. The latching bracket is generally wedge shaped as bracket 245 and enters a similar recess in handle 100 for latched engagement with the key 115. In the preferred embodiment of FIG. 10, four small domes 9248 are cast into the bracket 9245 and face the sidewall 201 and provide the electrode contacts for welding to the sidewall 210 via a spot welding process.

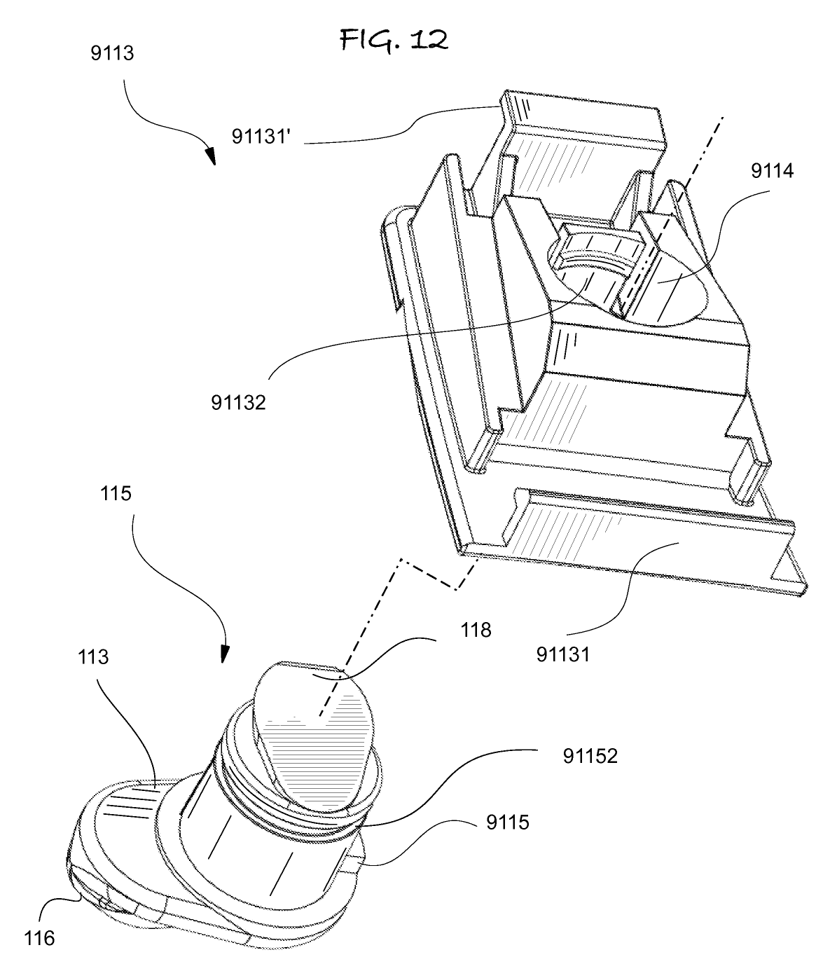

The handle 120 in FIG. 9 also has a forward recess 9110 for receiving the latching bracket 9245, but also an upper penetration 9112 above recess 9110 for receiving a key supporting insert 9113. The key supporting insert 9113 has a forward and rearward vertical brackets 91131 and 9113′ respectively for engaging the front and rear edges of the upper penetration 9112. One of brackets 91131 and 9113′ acts as a detent to latch under the side of penetration 9112 after the other vertical bracket is insert at an angle to grasp the opposing underside of the penetration 9112. The key supporting insert 9113 also has a generally centrally disposed circular hole or bore 9114 for receiving the key 115. The key 115 is rotated by lever 116 and the end of oval plate 113 and can be retained therein by various means. In the more preferred embodiment further illustrated in FIG. 12, the key 115 has an annular groove 91152 along the cylindrical surface above the annular protuberance 118. A detent 91132 extending downward along the curved wall below the hole 9114 engage the groove 91152 and prevents the key 115 from falling out of the insert 9113 after product assembly. A radial protrusion 9115 (FIG. 12) on the opposite side of the key 115 from lever 116, provides a means to properly align the key before connection with the detent, as the periphery of the hole 9114 is wider at one side to accept the radial protrusion. The vertical brackets or detents 91131, 931131′ and 91132 are not intended to be released after the handle 100 is assembled, and as such are essentially locking snap for engagement of the key retaining insert in the handle 100.

Alternative key retention means are threads or a radial protrusion that drops into a slot at the edge of the hole 9114, which after rotation of the key 115 is retained by lower rim surface of the circular hole 9114. The key 115 can also be held in the hole or bore 9114 with the U-shaped pin of the first embodiment, and can also similarly utilize a coiled spring 117 and balls 118 to engage dimples 1151 on sides of the key 115 below lever 116. The key 115 optionally has an upper portion that is threaded to engage mating threads in the receiving bore 9114.

The latching bracket 9245 has a wedge shaped rearward protrusion 9452 from a forward portion 2451 that attached to the sidewall 210 of the vessel 200. The forward portion 9451 supports a cantilevered plate 9117 that fits in the upper penetration 9453 of the rearward portion 9452.

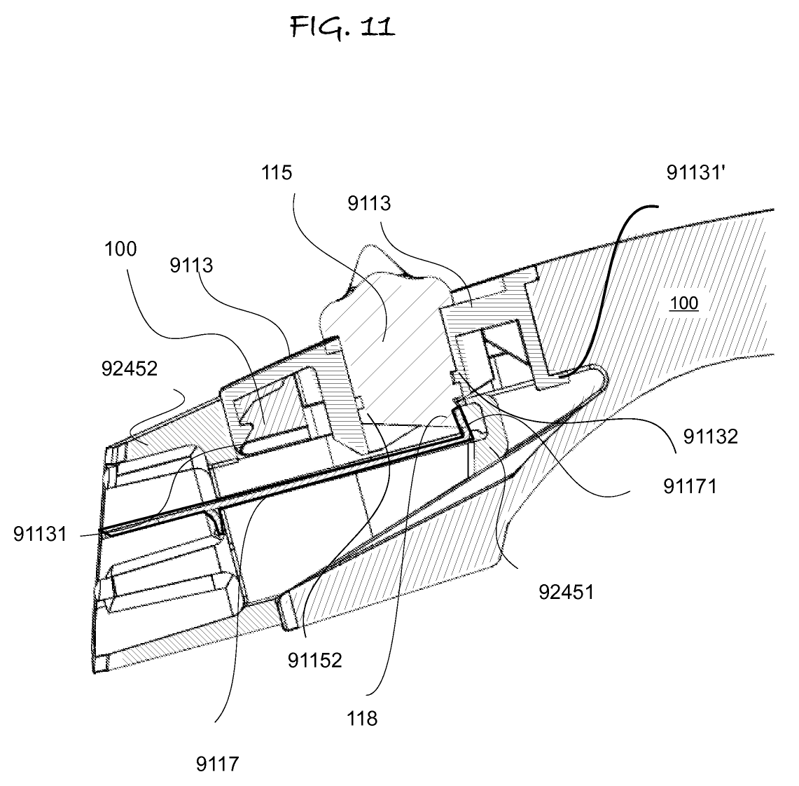

The handle 100 is presented to the vessel 200 as shown in FIG. 6A-D, so that the key 115 is in a position to engage the latching bracket 9245, in which the end of the angular protrusion 118 from the key 1115 engages an opposing wedge shaped portion of the bracket 9245. In the first embodiment, this opposing wedge shaped portion was provided by interior angled edge 255 of the channel 265, whereas in this second embodiment, the flexing plate 9117 portion of the latching bracket 245 provides such a wedge. In a more preferred embodiment the side of the plate 9117 proximal to the vessel 200 is retained in the forward portion of the bracket 9245 proximal to vessel wall 210 in slots or grooves formed in the sidewall thereof. Plate 9117 and has an opposing end wall 91171 for engagement with the angular protuberance 118 on the bottom of the key 115, as shown in FIG. 11. Preferably, this end wall 91171 is angled inward to form a wedge like mating edge for engaging the angular protrusion 118 at the bottom of the key 115. The plate 9117 is preferably secured in the bracket 9245 before attachment to the sidewall 210 of the vessel. By providing plate 9117 with side wings 91172 on the portion proximal to the vessel 200, which have partly circular front portions 91173 to be restrained by engaging portions of the bracket, the plate 9117 is retained in the bracket 9245 after attachment in assembly and cannot fall out and be lost by the user.

Rotation of the key 115 engages or releases the angular protrusion 118 provided by the forward tilt of the end wall 91171 of plate 9117, allowing the handle 110 to be rotated upward and removed from the latching bracket 9245.

The cantilevered plate 9117 is capable of flexing in response to engaging any lower portion of the key 118 so that the end wall 91171 will always oppose angular protrusion 118 when the handle 200 is fully advanced over the bracket 9245, that is when the forward faces 127 thereof contact an opposing edge 9247 at the interface between the rearward 9242 and forward 9241 portions thereof. This flexure of the cantilevered plate 9117 accommodates the common manufacturing variances of the bracket 9245 and handle 100 dimensions. Rotation of the key 115 to the locked position pushes the plate 9117 downward to the stops formed by lower internal edge in the forward portion. This urges the bracket 9245 and handle 100 together and removes mechanical play and tightens the handle 110 on the bracket 9245 and attached vessel 200.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

We claim:

1. An article of cookware, comprising:
a) a substantially horizontal bottom,
b) substantially upright sidewalls extending upward from and encircling said bottom to form a fluid retaining interior region, the sidewalls terminating at an upward rim of the vessel,
c) an outward extending bracket connecting to the upright sidewall of the vessel, the bracket having a lower wedge shaped outer portion and an upper portion opposing the lower wedge shaped portion,
d) at least one detachable handle extending outward from said substantially upright sidewall, the handle having;
i) a forward recess for receiving and selectively connecting to the wedge shaped outer portion of the bracket,
ii) a rotating locking key with an upper portion contained in a bore in the handle and a wedge shaped terminal portion of the key extends beyond a lower boundary of the bore
iii) wherein rotating the key in a first direction is operative to engage the wedge shaped terminal portion thereof to an upper portion of the bracket and rotating the key to a second direction opposite the first direction is operative to release the wedge shaped terminal portion thereof from the upper portion of the bracket.

2. An article of cookware according to claim 1 wherein the key has a means for latching connection to the upper portion of the bracket.

3. An article of cookware according to claim 2 wherein rotating the key to a locked position is operative to engage the wedge shaped terminal thereof to engage a first complimentary wedge shaped upper portion of the bracket.

4. An article of cookware according to claim 1 wherein the first complimentary wedge shaped portion of the bracket is at the edge of a plate disposed in the bracket.

5. An article of cookware according to claim 4 wherein the plate is fixed in a generally horizontal cantilevered position in a portion of the bracket which is proximal to the connection to the sidewall of the vessel and the plate is capable of flexing to allow the first complimentary wedge shaped portion to move upward to engage the lower portion of the key.

6. An article of cookware according to claim 3 wherein the forward recess of the handle has a wedge shaped lower portion disposed forward of the key to receive the lower wedge shaped portion of the bracket.

7. An article of cookware according to claim 1 in which the handle has means to identify if the key is in the first or second position corresponding to rotation between the first and second directions.

8. An article of cookware according to claim 1 in which the engaging portion of the bracket and handle are covered by a metal shell.

9. An article of cookware according to claim 6 wherein the handle is urged forward in a first upward position to receive the outward extending bracket and rotated downward thereafter to a second position to present the first complimentary wedge shaped upper portion of the bracket to receive the wedge shaped terminal portion of the key.

10. A handle for an article of cookware comprising:
a) an elongated grip portion having a distal end and a proximal end for connection to a cookware vessel,
b) a forward recess at the proximal end of the grip portion,
c) a cylindrical bore in the grip portion,
d) a locking key disposed for rotation with the cylindrical bore, the key having an upper end with lever that extends over an upper portion of the handle and lower end with a wedge shape portion that extends into the forward recess.

11. A handle for an article of cookware according to claim 10 in which the portion of wedge shaped end of the key is rotatable from a first position directed at the grip portion and a reversed position by the lever.

12. A handle for an article of cookware according to claim 9 in which the key is latchable in the first and reversed positions.

13. A handle for an article of cookware according to claim 11 wherein the key has cylindrical wall with dimples on opposing sides for receiving a ball that is urged into said dimples by a spring, wherein the spring provides the latching force.

14. A handle for an article of cookware according to claim 11 wherein the key has an annular groove in the cylindrical wall above the lower portion

15. A handle for an article of cookware according to claim 14 wherein the key is held in rotary engagement in the handle by a “U”-shaped bracket that engage the annular groove in the cylindrical wall of the key.

16. A handle for an article of cookware comprising:
a) an elongated grip portion having a distal end and a proximal end for connection to a cookware vessel,
b) a forward recess at the proximal end of the grip portion,
c) an upper recess at the proximal end of the grip portion,
d) a plate disposed in the upper recess having a cylindrical bore
e) a locking key disposed for rotation with the cylindrical bore, the key having an upper end with a rotation means and lower end with a wedge shape portion that extends into the forward recess.

17. A handle for an article of cookware according to claim 16 wherein the plate has detents on opposing sides for engaging an underside portion of the grip portion for retaining the plate in the upper recess.

18. A handle for an article of cookware according to claim 16 wherein the plate has a recessed upper surface that receives a lever that is attached to upper end of the key to provide the rotation means

19. A handle for an article of cookware according to claim 18 in which the portion of wedge shaped end of the key is rotatable from a first position directed at the grip portion and a reversed position by the lever.

20. A handle for an article of cookware according to claim 16 in which the key is latchable in the first and reversed positions.
